(19) United States
(12) Patent Application Publication
(10) Pub. No.: US 2003/0126995 A1
(43) Pub. Date: Jul. 10, 2003

(54) Fat reduced roasting and broiling

(76) Inventor: Francisco Borges Sebastiao, Richmond Hill (CA)

Correspondence Address: FRANCISCO BORGES SEBASTIAO, 46 PARK LANE CIRCLE, RICHMOND HILL, ON, L4C 6S8, CA

(21) Appl. No.: 10/137,191

(22) Filed: May 2, 2002

(30) Foreign Application Priority Data
May 23, 2001 (CA) 2,348,686

(51) Int. Cl. A47J 37/12

(52) U.S. Cl. 99/403; 99/422

(57) ABSTRACT

In an object which acts as a grid, it is used when roasting, broilling or grilling food. When placed inside a roasting pan it allows the fatty fluids excreted from the food which is beeing broiled, grilled or roasted to drain to the bottom of the pan thereby reducing the fat intake when the food is beeing consumed, which allows for healthier eating.

The oven roaster grid should be made out of the same kind of non-oxidising metal as the oven roaster pan itself so that it can withstand high temperatures when being used.

It is 0.7 centimeters in height and approximately 0.5 centimeters away from the edge of the pan being used all around it's peremiter.

It's purpose is to seperate the fat away from a roast when an oven roasting pan is being used for roasting or broiling

This is how it works;

In this example we are going to roast a turkey in the oven roasting pan.

We take our pan and pour our flavour giving fluids and spices inside just like we normally would.

We now place our grid inside and place the turkey on top of it. We can now cover the pan with it's lid and place the whole thing in the oven.

After about one and a half hours of roasting in the oven we will notice that our flavour giving liquids and spices we had poured into the pan are now sitting below the grid surface level and this is vital so that all the fat excreted from our roasting turkey can pass through the grid and sit below the grid surface level.

The result is we have separated the turkey from it's fat contents and we can now enjoy a healthier low fat flavourfull turkey roast, for our own benefit.

This grid has endless potentional usage. Besides having the potential for doing roasting such as roast turkey, roast beef, rib roast, roasted lamb chops and many more kinds of roasting we can use it for broiling and grilling steaks, fish, hamburgers, meat sausages, etc. etc.

This grid comes in three different forms, they are;

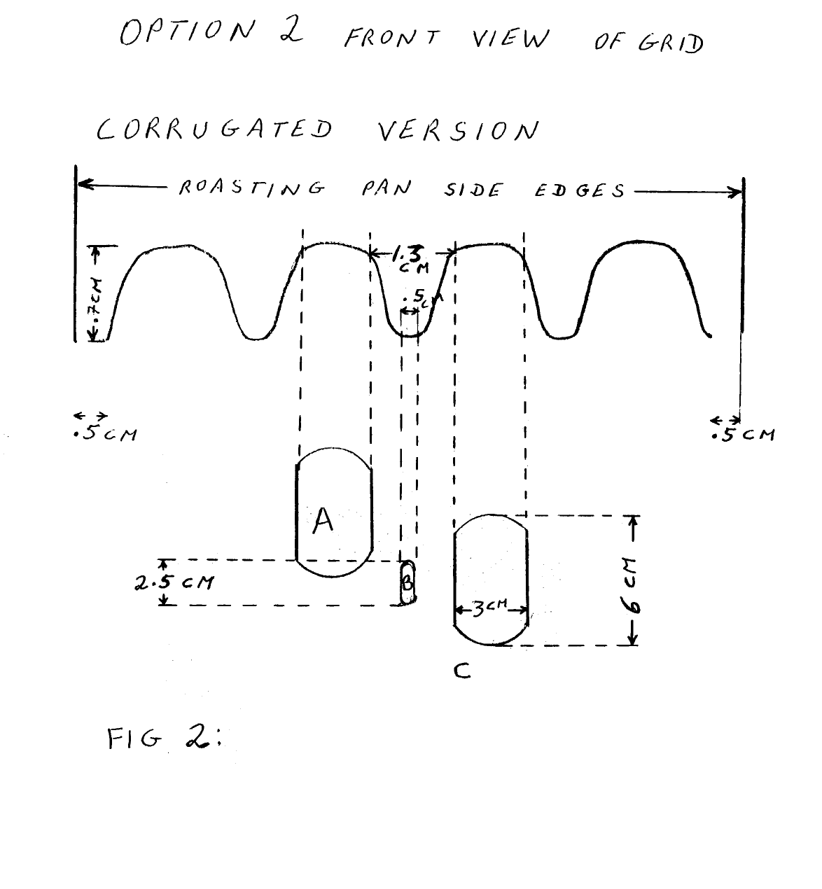

1 The uneven surface type. (Is sturdy. shown In FIG. 2.)

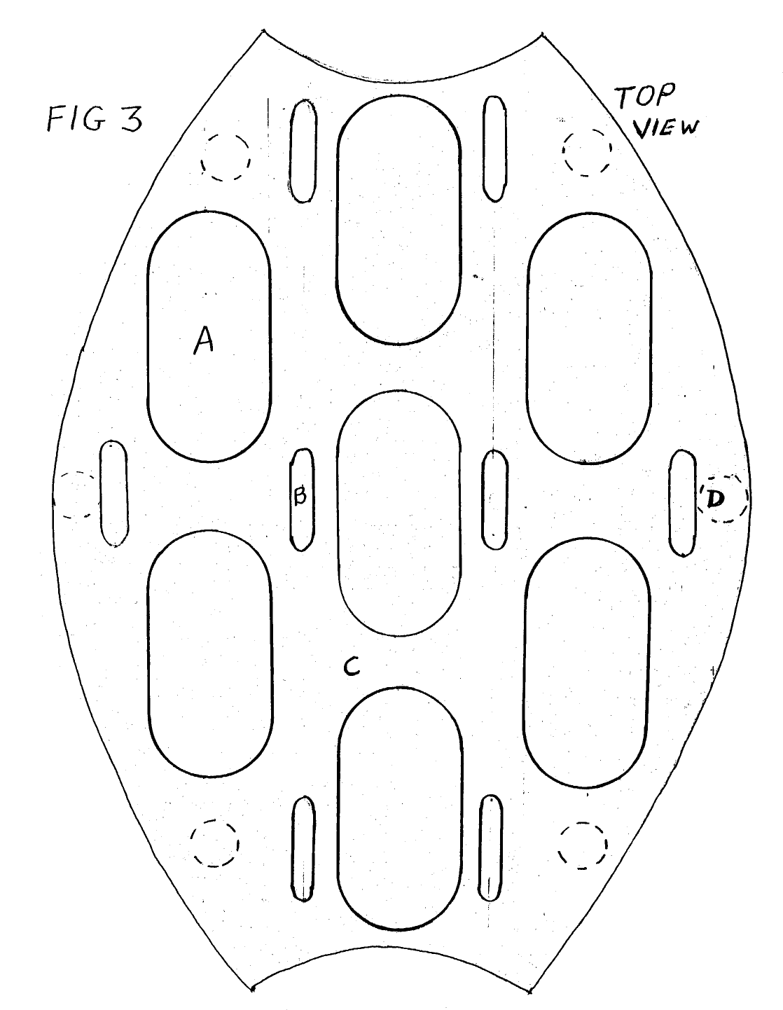

2 The flat surface type. (Has foot supports to make it sturdy as shown in FIG. 3.)

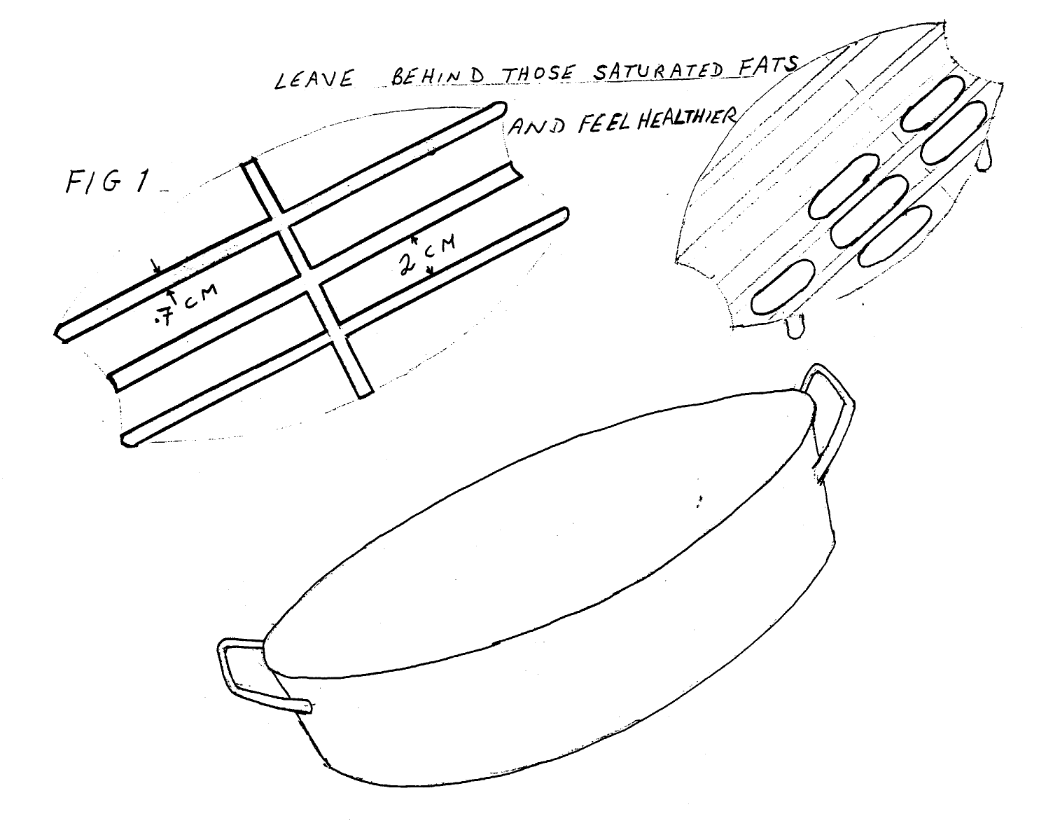

3 The cross bar type. (Has one or several bars in the middle joining all the cross bars together as shown in FIG. 1.)

When I say uneven surface I mean the surface of the grid is corrugated in shape. Holes A and B in FIG. 2 have been cut out of the surface and these are essential for fat drainage and heat passage way. These holes are 3 by 6 centimeters and 0.5 by 2.5 centimeters respectively. These holes are spaced apart approximately 1.3 centimeters with the larger holes positioned at the top and the smaller ones at the bottom of the grid. The grid itself is only 0.7 centimeters from top surface to bottom surface.

FIG. 3 shows us the top view of both the uneven surface and the flat surface type grids. They are identical in size and hole dimention. In the case of the flat surface type grid it's surface is flat as the name implies so feet support D in FIG. 3 have been added to raise the grid's height to the required 0.7 centimeters. These feet supports also make the grid sturdier.

FIG. 1 shows us the top view of the cross bar grid. This grid consists of parrallel bars spaced 2 centimeters apart with one or more bars running at a 90 degrees angle to them down the middle and joining all the bars together. These bars should have a dimention of 0.7 centimeters on one of it's sides to give us the required height, which is 0.7 centimeters. This grid can be made to the same size as the other two types and most importantly made from a non-oxidising metal that is able to withstand high oven temperatures.

As stated earlier in this description that this grid should be made to be able to withstand high oven temperatures we should not restrict ourselves to have it made exclusively out of metal although metal is preferred. Also the pan that we wish to use this grid on, should have no limitations as to any particular size, shape, make or type of material it is made of.

In this description I have demonstrated an example of an oval shaped grid (FIG. 3), again I should stress that we can make this grid any shape or form we wish for example square shaped if we so choose, nor are we limited to the design and hole perforation dimentions I have chosen in my example, but we can make them any shape, design and perforation size we want.

To sum it all up we should make the grid to the size and shape that best suits the pan it is to be used in.

Thank you for your attention!

1 A non-oxidising object to be placed inside a roasting pan, lying horizontally over the pan's bottom surface.

2 An object as defined in claim 1, gridded along it's surface so as to allow oily and fatty fluids to pass through it.
